(19) United States
(12) Patent Application Publication
(10) Pub. No.: US 2023/0073005 A1
(43) Pub. Date: Mar. 9, 2023

(54) PIPETTING DEVICE AND A METHOD OF PROCESSING A FLUID SAMPLE

(71) Applicant: Hombrechtikon Systems Engineering AG, Hombrechtikon (CH)

(72) Inventors: Hans-jürgen TIEDTKE, Bonn (DE); Harald QUINTEL, Steckborn (CH); Konstantin LUTZE, Uerikon (CH)

(21) Appl. No.: 17/796,255

(22) PCT Filed: Apr. 21, 2020
(86) PCT No.: PCT/EP2020/061077

§ 371 Date: Jul. 28, 2022

(51) Int. Cl. B01L 3/02; B01L 3/00; G01N 21/01

(52) U.S. Cl. CPC B01L 3/0275; B01L 3/021; B01L 3/502; G01N 21/01; B01L 2200/026; B01L 2300/0809

(57) ABSTRACT

A pipetting device for processing a fluid sample includes a receiving element and a pipette tip detachably arranged on the receiving element, a displacement element flow-connected to the pipette tip for generating a flow for receiving or ejecting the fluid sample. The pipetting device includes an optically transparent extension detachably arranged on the pipette tip in such a way that the extension is flow-connected to the displacement element via the pipette tip, so that the fluid sample can be received into the extension or can be ejected from the extension by the flow that can be generated by the displacement element.

### CROSS-REFERENCE TO RELATED APPLICATION

This application is a U.S. National Stage application of International Application No. PCT/EP2020/061077, filed Apr. 21, 2020, the contents of which is hereby incorporated by reference.

### BACKGROUND

### Field of the Invention

The disclosure relates to a pipetting device for processing a fluid sample, an optically transparent extension for the pipetting device, an automated laboratory apparatus for processing the fluid sample, and a method of processing the fluid sample.

### Background Information

When processing a plurality of samples, a plurality of processing steps must be performed. For this purpose, automated laboratory apparatuses are usually used since a precise pipetting of reagents into and out of containers such as microwell plates must be ensured.

Here, conventional automated laboratory apparatuses usually comprise a treatment chamber in which the samples are introduced in containers; a pipetting device for performing the processing steps: a movement device for moving the pipetting device in the treatment chamber and an electronic control device which controls and instructs the pipetting device and other parts of the automated laboratory apparatus for performing the processing steps.

Thus, an automated sample preparation process with increased efficiency and improved throughput is ensured by using the automated laboratory apparatuses.

However, pipetting devices are not only used in automated laboratory apparatuses, but also generally for dosing liquids. These liquids are received and dispensed into a pipette tip of the pipetting device through a tip opening. For this purpose, a displacement element is integrated into the pipetting device, in particular a displacement element for a gas, which is flow-connected to the pipette tip by a receiving element for the pipette tip. An air cushion is displaced by the displacement element so that liquid is sucked into the pipette tip and ejected from it. The displacement element is usually a cylinder with a displaceable piston therein.

The pipette tips are detachably connected to the receiving element so that they can be exchanged for a fresh pipette tip after use. In this way, contamination can be avoided in subsequent dosing operations. Pipette tips for single use are available inexpensively made of plastic.

The receiving element particularly comprises a projection for attaching pipette tips, preferably of cylindrical or conical shape, onto which the pipette tip can be clamped with a matching insertion opening or receptacle. This can be done without touching the pipette tip by pressing the projection into the insertion opening of the pipette tip provided in a holder.

In order to avoid contamination, pipetting devices preferably have an ejection device with a drive device and an ejector. By actuating the drive device, the ejector is displaced such that it releases the pipette tip from the projection without the user having to touch it. For this purpose, the drive device usually has a mechanism which can be actuated manually by a button (or automatically in the case of an automated laboratory apparatus) in order to release the pipette tip from the receiving element.

Extremely low volumes in the range of microliters and picoliters can also be processed with pipetting devices. Such pipetting devices are particularly useful in the processing of biochemical/biotechnological samples including biological samples such as biomolecules (for example DNA, RNA or proteins).

Conventional automated laboratory apparatuses often also have integrated optical detection devices for analyzing the samples. The analysis is usually done with optical techniques such as spectroscopy or photometry.

In particular for biomolecules, luminescence spectroscopy is an important analytical method in which the emission light, which is generated based on photon absorption of the biomolecules, is evaluated.

For this purpose, fluorescent chemical groups can be attached to large biomolecules by fluorescent labeling, which then serve as markers for this biomolecule.

In many processes, the concentration of the fluid samples (i.e., the relevant molecules in solution) in particular plays a role for further processing, which can be easily determined, in particular, by fluorescence spectroscopy optical density (a measure of the attenuation of a radiation after it has passed through a medium) can also be used to determine the concentration.

### SUMMARY

It has been determined that this optical analysis of the fluid samples in the detection devices is usually very time-consuming and requires expensive analysis equipment for the storage/receiving of the fluid samples.

It is therefore an object of the disclosure to provide a pipetting device, an automated laboratory apparatus and a method for processing a fluid sample, which avoid the adverse effects known from the conventional devices.

The object can be met by a pipetting device, an automated laboratory apparatus and a method for processing a fluid sample with the features described herein.

The disclosure further relates to particularly advantageous embodiments of the invention.

According to an embodiment of the invention, a pipetting device for processing a fluid sample is proposed, comprising a receiving element and a pipette tip detachably arranged on the receiving element and a displacement element flow-connected to the pipette tip for generating a flow for receiving and/or ejecting the fluid sample.

The pipetting device further comprises an optically transparent extension, which extension is arranged detachably on the pipette tip in such a way that the extension is flow-connected to the displacement element via the pipette tip, so that the fluid sample can be received into the extension and/or can be ejected from the extension by the flow that can be generated by the displacement element.

Within the framework of the disclosure, the fact that the pipette tip is flow-connected to the displacement element can be understood to mean in particular that a first interior space of the pipette tip (which is suitable for receiving a liquid or the fluid sample) is connected to the displacement element in such a way that a flow connection to the extension can be established by actuation of the displacement element via the first interior space (or the fluid sample or a liquid can be received in the first interior space if the pipetting device is used without an extension). Within the framework of the disclosure, the fact that the extension is flow-connected to the displacement element via the pipette tip, can be understood to mean in particular that a second interior space of the extension (which is also suitable for receiving the liquid or the fluid sample) is connected the first interior space in such a way that the fluid sample (or the liquid) can be received in the second interior space by actuation of the displacement element, because there is a flow connection to the displacement element via the first interior space.

According to the disclosure, an optically transparent extension for a pipetting device according includes an amorphous polymer is further proposed. The extension can in particular comprise a plastic, especially can include cycloolefin copolymer. Cycloolefin-Copolymers are usually obtained by metallocene-catalyzed copolymerization of cycloolefins with alk-l-enes. In contrast to semi-crystalline polymers such as polyethylene and polypropylene, cycloolefin copolymers are amorphous and thus optically transparent. Due to the low birefringence and optical transparency, the cycloolefin copolymers can be used particularly preferably for the optical analyses according to the embodiments of (in the detection device).

According to an embodiment of the invention, an automated laboratory apparatus for processing a fluid sample is further proposed, comprising a treatment chamber for receiving the fluid sample; the pipetting device, which pipetting device is arranged in the treatment chamber to perform at least one processing step on the fluid sample; a movement device arranged movably in at least one first spatial direction of the treatment chamber, which movement device is connected to the pipetting device in such a way that the pipetting device can be moved through the treatment chamber by the movement device, a detection device arranged in the treatment chamber for analyzing the fluid sample; and an electronic control device which is signal-connected to the pipetting device, the movement device and the detection device.

In addition, a method according to an embodiment of the invention of processing a fluid sample with the automated laboratory apparatus is proposed, comprising: providing the automated laboratory apparatus; introducing the fluid sample into the treatment chamber; receiving the fluid sample into the optically transparent extension by the pipetting device, moving the pipetting device by the movement device through the treatment chamber to the detection device; introducing the optically transparent extension with the fluid sample into the detection device; analyzing the fluid sample by the detection device.

Within the framework of the disclosure, “optically transparent” means that the extension (at least in a region of the extension) is transmissive for electromagnetic waves/radiation, in particular for electromagnetic waves/radiation in the UV/Vis range and/or NIR range, respectively for the primary radiation.

Due to the optically transparent extension according to embodiments of the invention, in particular the advantage is achieved that not the complete pipette tip for analyzing the fluid sample does not have to include an optically transparent material, in particular an amorphous polymer, whereby the costs for the single-use tips can be reduced.

Within the framework of this application, “detachable” can be understood that both the pipette tip and the extension are not firmly attached but can be easily removed and thus can be easily removed and disposed of particularly as a single-use pipette tip/extension.

Within the framework of this disclosure, the term “fluid sample” can be understood to mean, in particular, a sample comprising a fluid containing substances such as biomolecules (inter alia DNA, RNA, nucleic acids, proteins, cells and cell components, monomers) or other chemical substances. Within the framework of the disclosure, a liquid can be, for example, a suitable solvent.

In the pipetting device according to embodiments of the invention, the displacement element can be integrated into the receiving element, in particular arranged inside the receiving element. Here, the displacement element can be designed as a piston that can be displaced in the receiving element.

The extension according to embodiments of the invention can comprise an attachment region with which the extension can be arranged on the pipette tip and can comprise a measuring region arranged on the attachment region at which an analysis of the fluid sample can be performed. For this purpose, the measuring region can be specially shaped and, in particular, a cross-sectional profile of the measuring region perpendicular to a dispensing axis can be rectangular or square. In practice, a cross-sectional profile of the optically transparent extension perpendicular to the dispensing axis can also simply be rectangular or square. In doing so, the extension can be secured against twisting by form locking with the pipette tip. An alignment of the extension before analysis is therefore not necessary.

In practice, the attachment region can be arranged at a dispensing region (at the opening) of the pipette tip, at which dispensing region the fluid sample can be received into and ejected from the pipette tip.

In an embodiment of the invention, the detection device can comprise a radiation source for irradiating the fluid sample with a primary radiation and a detector for receiving a secondary radiation originating from the fluid sample (for analysis of the fluid sample). The radiation source thus generates an electromagnetic radiation (the primary radiation). The secondary radiation is in particular an electromagnetic secondary radiation emitted/originating from the fluid sample, which secondary radiation is induced by an interaction of the primary radiation with the fluid sample.

Here, UV/Vis radiation and/or NIR radiation, in particular in the wavelength range of 190-1000 nm, especially 365-720 nm, is particularly preferably used as primary radiation. A diode, in particular a silicon photodiode or a vacuum photodiode, is particularly suitable as a detector. A laser, a deuterium lamp, a tungsten lamp, a halogen lamp, a mercury vapor lamp, or a LED (light emitting diode) can be used as radiation sources.

In practice, the detection device can also comprise a plurality of detectors and/or radiation sources. The radiation sources can emit different wavelengths or wavelength ranges as primary radiation. Here, the use of two radiation sources is particularly preferred, which are designed as a first radiation source (preferably first LED) with a first wavelength (e.g., 450-490 nm) and a second radiation source (preferably second LED) with a second wavelength (e.g., 600-630 nm) If a plurality of radiation sources is present, the analysis can be performed confocally. The beam paths of the primary radiation from the different radiation sources are thus directed to a common focal point in the fluid sample.

Thus, the detection device can be a photometer, in particular a spectrometer, especially a fluorometer. The fluorometer measures the parameters of fluorescence of the fluid sample: intensity and wavelength distribution of the emission spectrum (of the secondary radiation) after excitation by the primary radiation.

Within the framework of the disclosure, however, an absorption measurement is used particularly preferably as the measurement principle, whereby the radiation source generates primary radiation in the UV/Vis range and/or NIR range (in particular of a single wavelength, such as 280 nm) and the light beam attenuated by passing through the sample and the extension (secondary radiation) is captured by the detector. To characterize the absorption intensity, the absorbance or optical density (measure for attenuation of the primary radiation in a medium (sample and extension)) is preferably used.

Preferably, the absorption of the fluid sample is measured by arranging the fluid sample in the extension according to embodiments of the invention in a measuring point of the detection device between the radiation source and the detector.

In a particularly preferred embodiment of the method according to the invention, a liquid is received into the pipette tip and is ejected from the pipette tip prior to receiving the fluid sample into the optically transparent extension. Thus, this liquid can be moved through the treatment chamber by the pipetting device, in particular transferred between different containers/wells. Subsequently, in the method according to embodiments of the invention, the extension can then be arranged at the pipette tip and the fluid sample can be received in the extension for analysis. This has the advantage that the fluid sample can be analyzed without changing the pipette tip (after using the pipette tip) simply by applying the extension. This is particularly advantageous if, for example, a liquid is introduced into the fluid sample from the pipette tip and then the fluid sample is received into the extension after the extension has been applied. Without changing the pipette tip, contamination is avoided, and analysis of the fluid sample is possible.

In practice, the analysis can comprise irradiating the fluid sample with the primary radiation by the radiation source of the detection device and capturing the secondary radiation originating from the fluid sample by the detector of the detection device. During the analysis, a concentration of the fluid sample can also be determined on the basis of the secondary radiation.

In practice, a container is usually arranged in the treatment chamber to receive the fluid samples. In particular, the container can be a microtiter plate, wherein the microtiter plate comprises a plurality of wells for receiving the fluid samples (or different fluid samples).

In practice, the pipetting device can have a conventional ejection device with a drive device and an ejector in order to eject the pipette tips by actuating the drive device by displacing the ejector in such a way that it releases the pipette tip from the receiving element without the user having to touch it. In addition, the ejection device can have an extension ejector for ejecting the extension by actuating the drive device by displacing the extension ejector in such a way that it releases the extension from the pipette tip without the user having to touch it. For this purpose, the extension ejector can be designed as a sleeve which moves around the pipette tip to the extension and which has such a larger radius than the pipette tip and such a smaller radius than the extension that only the extension is ejected. In addition, the extension ejector could comprise a gripping mechanism which fixes the pipette tip during ejection of the extension. Due to the extension ejector, it is possible to use the pipette tip for further steps after ejecting the extension.

The fact that the electronic control device is signal-connected to the pipetting device, the movement device and the detection device, means that in the operating state the control device sends control signals for performing the processing steps to the pipetting device, the movement device and the detection device. In addition, signals can also be received from the pipetting device, the movement device and the detection device.

The signal connection can be made via a cable connection or wirelessly. In the case of the wireless signal connection, the data/signal transmission takes place via free space (air or vacuum) as the transmission medium. The transmission can be done by directional or non-directional electromagnetic waves, wherein a range of the frequency band to be used can vary from a few hertz (low frequency) to several hundred terahertz (visible light) depending on the application and the technology used. Preferably, Bluetooth or WLAN is used for this. Thus, not only the detection device can be controlled by the control device, but after the fluid samples have been analyzed, the measured data can be transmitted to the control device for evaluation, for example to determine a concentration of the fluid sample before further processing.

Of course, it is preferred that the movement device can also be moved in a second spatial direction of the treatment chamber, orthogonal to the first spatial direction, as well as in a third spatial direction of the treatment chamber, orthogonal to the first spatial direction and the second spatial direction so that the detection device can be moved flexibly in the entire automated laboratory apparatus. The movement device is preferably driven by an electric motor such as a servo motor and can move, for example, as a freely movable arm or via rails.

In the method according to embodiments of the invention (or in the operating state), the pipetting device can thus be moved through the treatment chamber by the movement device in all spatial directions (first, second and third spatial directions within the framework of the application).

An advantage of the pipetting device according to embodiments of the invention is in particular that known automated laboratory apparatuses can be easily retrofitted to an automated laboratory apparatus, since the already existing pipetting devices can be replaced by the pipetting device according to the disclosure.

### BRIEF DESCRIPTION OF THE DRAWINGS

Embodiments of the invention will be explained on more detail hereinafter with reference to the drawings.

FIG. 1 illustrates a schematic representation of an automated laboratory apparatus according to an embodiment of the invention:

FIG. 2 illustrates a schematic representation of a further embodiment of an automated laboratory apparatus according to an embodiment of the invention;

FIG. 3A-F illustrates a schematic representation of the use of the pipetting device according to an embodiment of the invention;

### DETAILED DESCRIPTION

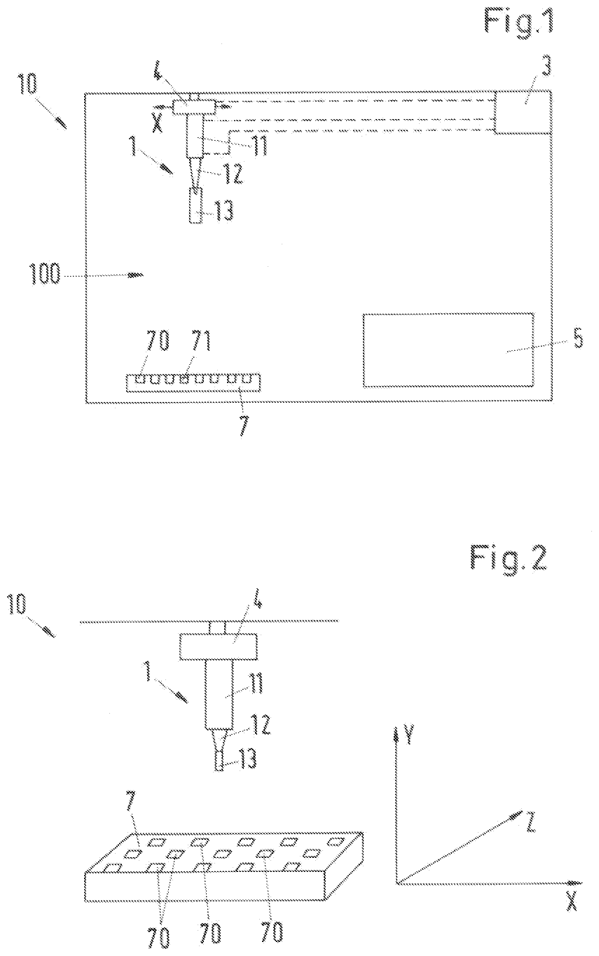

FIG. 1 shows a schematic representation of an automated laboratory apparatus 10 according to an embodiment of the invention.

The automated laboratory apparatus 10 for processing a fluid sample 71 comprises a treatment chamber 100 for receiving the fluid sample and a pipetting device 1 according to an embodiment of invention, which pipetting device 1 is arranged in the treatment chamber 100 to perform at least one processing step on the fluid sample 71.

The pipetting device 1 for processing a fluid sample 71 comprises a receiving element 11 and a pipette tip 12 detachably arranged on the receiving element 11 and a displacement element (which is integrated into the receiving element 11) flow-connected to the pipette tip 12 for generating a flow for receiving and/or ejecting the fluid sample 71.

Furthermore, the pipetting device 1 comprises an optically transparent extension 13, which extension 13 is arranged detachably on the pipette tip 12 in such a way that the extension 13 is flow-connected to the displacement element via the pipette tip 12, so that the fluid sample 71 can be received into the extension 13 and/or can be ejected from the extension 13 by the flow that can be generated by the displacement element.

In addition, the automated laboratory apparatus 10 comprises a movement device 4 arranged movably in at least one first spatial direction X of the treatment chamber 100. This movement device 4 is connected to the pipetting device 1 in such a way that the pipetting device can be moved through the treatment chamber 100 by the movement device 4. Furthermore, a detection device 5 is arranged in the treatment chamber 100 for analyzing the fluid sample 71, as well as an electronic control device (electronic controller) 3 which is signal-connected to the pipetting device 1, the movement device (mover) 4 and the detection device (detector) or analysis unit (analyzer) 5. In addition, a container 7 with a plurality of wells 70 for receiving the fluid samples 71 is arranged in the treatment chamber 100.

It is substantial that the extension 13 is optically transparent, because this is the only way to perform an analysis of the fluid sample 71 in the detection device 5.

The steps for processing/analyzing (method) of the fluid sample 71 are controlled by the electronic control device 3, which is signal-connected to the pipetting device 1, the movement device 4 and the detection device 5. Thus, it is predetermined by the electronic control device 3 that the fluid sample 71 is received into the extension 13 by actuating the displacement mechanism and is introduced with the extension 13 into the detection device 5 for analysis, so that the fluid sample 71 can be analyzed in the extension 13.

In the operating state, the control device 3 the control device 3 can thus send control signals to the pipetting device 1, the movement device 4, and the detection device 5 for performing various processing steps. Of course, the control device 3 can also receive signals from the pipetting device 1, the movement device 4 and the detection device 5. The signal connection is indicated by the dashed lines.

The detection device 5 is controlled by the control device 3 in such a way, that the analysis of the fluid sample 71 is performed after introduction of the extension 13. After analyzing the fluid samples 71, the measured data is transmitted from the detection device 5 to the control device 3 for evaluation.

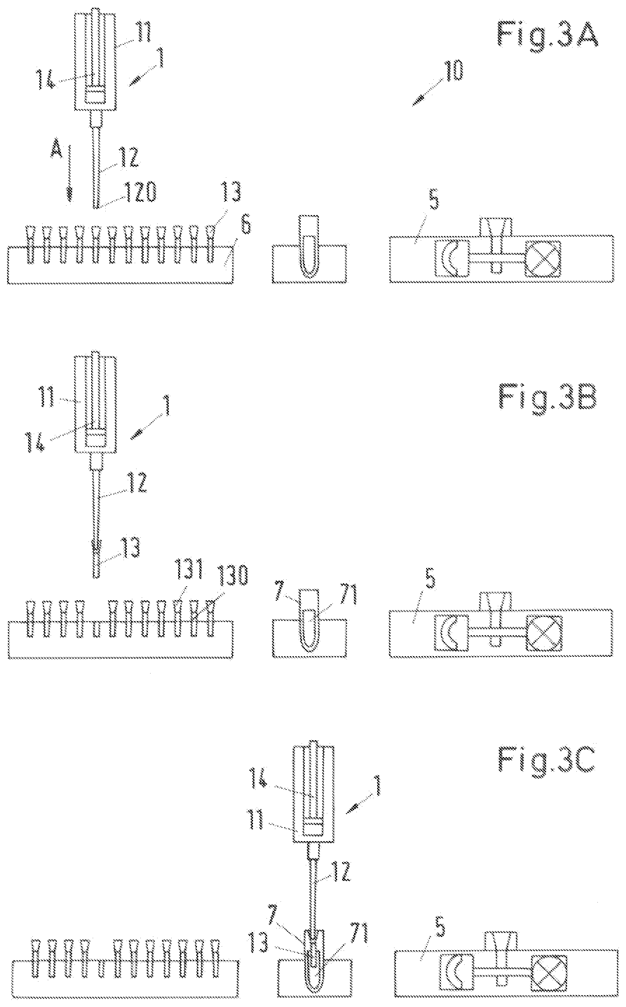

FIG. 2 shows a schematic representation of a further embodiment of an automated laboratory apparatus 10 according to the invention with a structure equivalent to the automated laboratory apparatus 10 according to FIG. 1.

However, the movement device 4 can additionally be moved in a second spatial direction Y of the treatment chamber, which is orthogonal to the first spatial direction X, and in a third spatial direction Z of the treatment chamber, which is orthogonal to the first spatial direction X and the second spatial direction Y, so that the detection device 5 can be flexibly moved to the various wells 70 of the container 7, which is designed as a microtiter plate, as well as to the detection device 5.

In the operating state, the pipetting device 1 can thus be moved by the movement device 4 in all spatial directions X, Y, Z through the treatment chamber 100. In this way, in particular, an application of the pipette tips 12 to the receiving element 11 and an application of the extensions 13 to the pipette tips 12 (and a respective ejection of the pipette tips 12/extensions 13) can also be performed.

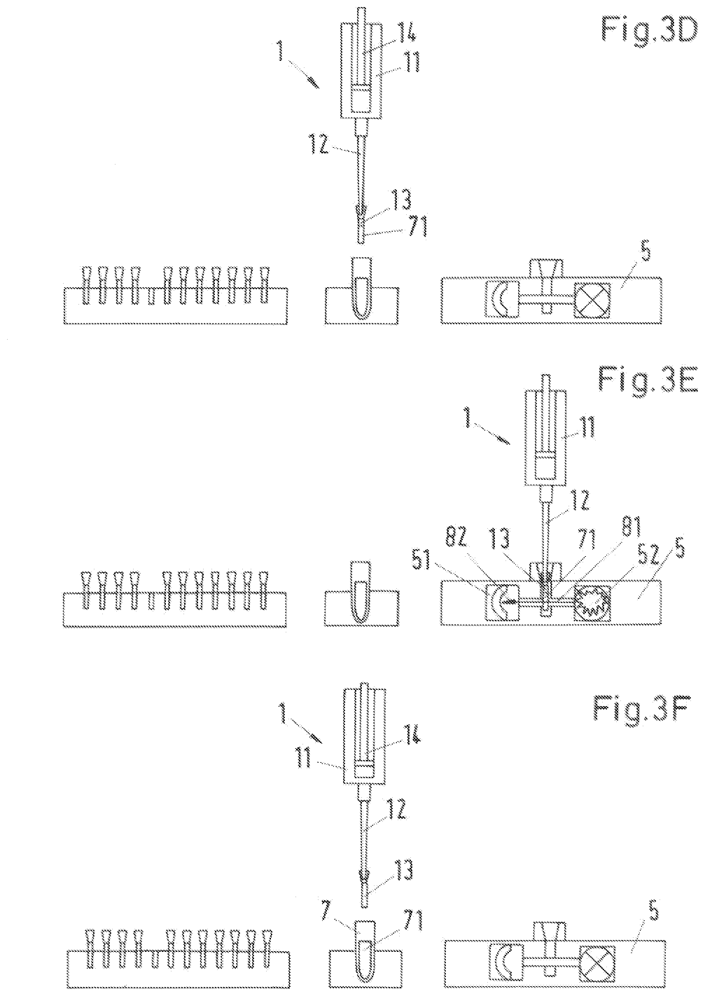

FIG. 3A-F show a schematic representation of the use of the pipetting device 1 according to an embodiment of the invention.

The pipetting device 1 according to FIG. 3A-F comprises the receiving element 11 and a pipette tip 12 detachably arranged on the receiving element 11. The displacement element 14 for generating the flow for receiving and/or ejecting the fluid sample 71 is integrated into the receiving element 11 and thus flow-connected to the pipette tip 12. The displacement element 14 is designed as a displaceable piston, which generates the flow in the form of an air cushion displacement by moving along a dispensing axis A.

In FIGS. 3A and 3B, the extension 13 is applied to the pipette tip 12. For this purpose, the extension 13 comprises an attachment region 131 into which the pipette tip is inserted, whereby the extension 13 is received by the pipetting device 1 from the storage 6.

In addition, the extension 13 comprises a measuring region 130 arranged on the attachment region 131 at which measuring region 130 the analysis of the fluid sample 71 is performed later.

For a better analysis, the optically transparent extension 13 consists of an amorphous plastic such as cycloolefin copolymer and a cross-sectional profile of the measuring region 130 perpendicular to the dispensing axis A is rectangular.

Subsequently, the pipetting device 1 in FIG. 3C is moved to the container 7 with the fluid sample 71 and receives the fluid sample 71 by moving the displacement mechanism 14 into the extension 13.

In FIG. 3D, the extension 13 with the fluid sample 71 is moved to the detection device 5, and in FIG. 3E, it is introduced into the detection device 5.

The detection device 5 comprises a radiation source 52 for irradiating the fluid sample 71 with a primary radiation 81 and a detector 51 for receiving a secondary radiation 82 originating from the fluid sample 71.

Thus, the fluid sample 71 is irradiated by the radiation source 52 with the primary radiation 81 and the detector receives the secondary radiation 82 originating from the fluid sample 71.

The radiation source 52 preferably generates the primary radiation 81 as an electromagnetic radiation in the UV/Vis range, in particular in the wavelength range of 190-1000 nm, especially of 365-720 nm. The secondary radiation 82 is in particular an electromagnetic secondary radiation 82 originating from the fluid sample, which secondary radiation 82 is induced by an interaction of the primary radiation 81 with the fluid sample. An absorption measurement is used as the measurement principle, wherein the light beam 82 (secondary radiation) attenuated by passing through the sample 71 and the extension 71 is captured by the detector 51.

In addition, a liquid can be received into the pipette tip 12 and can be ejected from the pipette tip 12 prior to receiving the fluid sample 71 into the optically transparent extension 13, and only then the extension 13 can be arranged on the pipette tip 12. Thus, this liquid can be moved by the pipetting device 1 in the treatment chamber 100, in particular being transferred between different containers/wells. Subsequently, in the method according to an embodiment of the invention, the extension 13 can then be arranged on the pipette tip 12 to receive the fluid sample 71 into the extension for analysis. This has the advantage that the fluid sample 71 can be analyzed without changing the pipette tip 12 (after using the pipette tip 12) simply by applying the extension 13. Without changing the pipette tip 12, both contamination is avoided, and an analysis of the fluid sample is enabled.

1. A pipetting device for processing a fluid sample comprising:
a receiving element;
a pipette tip detachably arranged on the receiving element;
a displacement element flow-connected to the pipette tip and configured to generate a flow for receiving or ejecting the fluid sample,
the pipetting device comprising an optically transparent extension detachably arranged on the pipette tip such that the extension is flow-connected to the displacement element via the pipette tip, so that the fluid sample is capable of being received into the extension or is capable of being ejected from the extension by the flow generated by displacement element.

2. The pipetting device according to claim 1, wherein the displacement element is integrated into the receiving element.

3. The pipetting device according to claim 1, wherein the extension comprises an attachment region and is arranged on the pipette tip and comprises a measuring region arranged on the attachment region at which an analysis of the fluid sample is configured to be performed.

4. The pipetting device according to claim 2, wherein the attachment region is arranged at a dispensing region of the pipette tip, at the dispensing region configured to receive the fluid sample into the pipette tip and eject the fluid sample from the pipette tip.

5. The pipetting device according to claim 1, wherein the optically transparent extension comprises a polymer.

6. The pipetting device according to claim 1, wherein the optically transparent extension includes an amorphous polymer.

7. The pipetting device according to claim 1, wherein a cross-sectional profile of the optically transparent extension is rectangular.

8. An optically transparent extension for the pipetting device according to claim, comprising:
an amorphous polymer.

9. An automated laboratory apparatus for processing a fluid sample, comprising:
a treatment chamber configured to receive the fluid sample;
the pipetting device according to claim 1, arranged in the treatment chamber and configured to perform a processing step on the fluid sample;
a movement device movably arranged in a first spatial direction of the treatment chamber, the movement device connected to the pipetting device such that the pipetting device is capable of being moved through the treatment chamber by the movement device;
a detection device arranged in the treatment chamber and configured to analyze the fluid sample; and
an electronic controller signal-connected to the pipetting device, the movement device and the detection device.

10. The automated laboratory apparatus according to claim 9, wherein the detection device comprises a radiation source configured to irradiate the fluid sample with a primary radiation and a detector configured to receive a secondary radiation originating from the fluid sample.

11. The automated laboratory apparatus according to claim 10, wherein the detector is a UV-VIS-NIR spectrometer or a diode.

12. The automated laboratory apparatus according to claim 10, wherein the radiation source is a deuterium lamp, a tungsten lamp, a halogen lamp, a mercury vapor lamp, or a LED.

13. The automated laboratory apparatus according to claim 10, wherein the detection device comprises a plurality of detectors or radiation sources.

14. The automated laboratory apparatus according to claim 9, wherein a container configured to receive the fluid samples arranged in the treatment chamber.

15. The automated laboratory apparatus according to claim 14, wherein the container is a microtiter plate.

16. The automated laboratory apparatus according to claim 9, wherein the detection device is a photometer.

17. The automated laboratory apparatus according to claim 9, wherein the movement device is configured to be moved in a second spatial direction of the treatment chamber, the second spatial direction orthogonal to the first spatial direction, and in a third spatial direction of the treatment chamber, the third spatial direction orthogonal to the first spatial direction and the second spatial direction.

18. A method of processing a fluid sample with an automated laboratory apparatus comprising:
providing an automated laboratory apparatus according to claim 9;
introducing the fluid sample into the treatment chamber;
receiving the fluid sample into the optically transparent extension by the pipetting device;
moving the pipetting device by the movement device through the treatment chamber to the detection device;
introducing the optically transparent extension with the fluid sample into the detection device;
analyzing the fluid sample by the detection device.

19. The method according to claim 18, further comprising receiving a liquid into the pipette tip and ejecting the liquid from the pipette tip prior to receiving the fluid sample into the optically transparent extension, and subsequently arranging the extension on the pipette tip.

20. The method according to claim 18, further comprising irradiating the fluid sample with a primary radiation by means a radiation source of the detection device and receiving a secondary radiation originating from the fluid sample by a detector of the detection device.

21. The method according to claim 20, further comprising determining a concentration of the fluid sample based on the secondary radiation.
